(19) United States
(12) Patent Application Publication
(10) Pub. No.: US 2008/0307502 A1
(43) Pub. Date: Dec. 11, 2008

(54) USER MESSAGE MANAGEMENT METHODS AND SYSTEMS

(75) Inventor: Shang-Ching Hung, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei (TW)

(21) Appl. No.: 11/759,310

(22) Filed: Jun. 7, 2007

(51) Int. Cl. H04L 9/32

(52) U.S. Cl. 726/4

(57) ABSTRACT

User message management methods and systems for use in an IPMI (Intelligent Platform Management Interface) system. A BMC (Baseboard Management Controller) receives a request to access a user message list in a storage unit from a console. The BMC performs operations by accessing at least one user message in the user message list based on the request.

### BACKGROUND OF THE INVENTION

1. Field of the Invention

The disclosure relates generally to IPMI (Intelligent Platform Management Interface) management, and, more particularly to user message management methods and systems in an IPMI system.

2. Description of the Related Art

With the popularity of electronic devices, such as computer systems, communication devices, and network devices, performance and execution status of the devices need to be stable. IPMI is an industry-standard protocol defining hardware and firmware monitoring and managing in a computer system, such as monitoring CPU/chip temperature, fan speed and information relative to the chassis, power on/off, and others.

IPMI operates independently from the OS (Operating System) of the computer system and allows system management in the absence of the OS or system management software, or even if the system is not powered on. IPMI defines a plurality of interfaces, such as IPMB (Intelligent Platform Management Bus), KCS (Keyboard Controller Style) (System-BMC interface), UART (Universal Asynchronous Receiver/Transmitter), or LAN (Local Area Network). An IPMI system comprises a BMC (Baseboard Management Controller) coupled with sensors in a chassis, and satellite management controllers via the I²C (Inter-Integrated Chip) implemented IPMB. The BMC receives detected data from the sensors and satellite management controllers, and stores the data in a storage unit, such as EEPROM (Electrically Erasable Programmable Read-Only Memory).

Data in the storage unit at least comprises a SDR (Sensor Data Record) repository, a FRU (Field Replaceable Unit), and SELs (System Event Logs). The SDR repository provides the properties of the individual sensors present on the board. For example, sensors may be for temperature, fan speed, voltage, and others. The FRU holds the inventory information, such as vendor id, manufacturer, and others of the devices. The SEL is generated if a specific event occurs. The SEL records the status information of a sensor or the system corresponding to the event. The information in the storage unit can be used for system management.

Management clients or applications can couple to the BMC to access the information in the storage unit, or perform operations thereon via the various interfaces. The information such as SDR in the storage unit and firmware for the BMC may be updated by users. Conventionally, no information for the update is recorded, resulting in difficulties for system management. For example, if a user updates firmware by adding a new sensor driver, the new sensor driver may not be shared by other users since no information for the firmware update is recorded. If a user updates a SDR, the reading for other users may be incorrect.

### BRIEF SUMMARY OF THE INVENTION

User message management methods and systems are provided.

In a user message management method for use in an IPMI system, a request to access a user message list in a storage unit is received from a console by a BMC. Operations are performed by accessing at least one user message in the user message list based on the request.

A user message management system for use in an IPMI system comprises a storage unit and a BMC. The storage unit comprises a user message list. The BMC receives a request to access the user message list from a console, and performs operations by accessing at least one user message in the user message list based on the request.

User message management methods and systems may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a user message management system;

FIG. 2 is a schematic diagram illustrating a format of a user message;

FIG. 3 shows an example of a user message list;

FIG. 4 is a schematic diagram illustrating a layered structure of a request;

FIG. 5 shows an example of an authority table;

FIG. 6 is a flowchart of an embodiment of a user message management method;

FIG. 7 is a flowchart of an embodiment of a request layering method; and

FIG. 8 is a flowchart of an embodiment of a request de-layering method.

### DETAILED DESCRIPTION OF THE INVENTION

User message management methods and systems are provided.

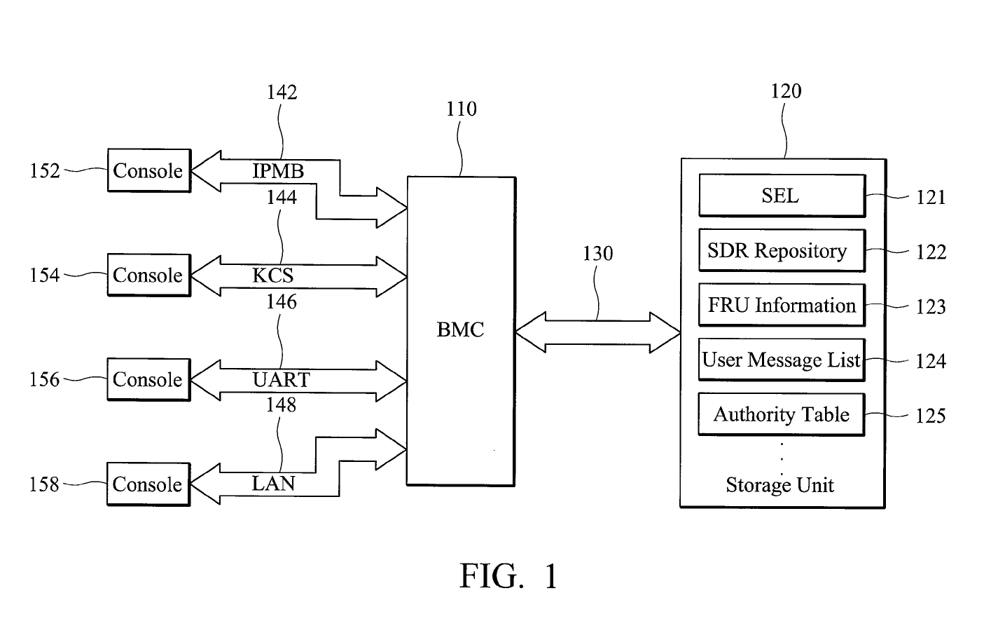

FIG. 1 is a schematic diagram illustrating an embodiment of a user message management system.

The user message management system may be use in an IMPI system. The system comprises a BMC 110, a storage unit 120 such as an EEPROM (Electrically Erasable Programmable Read-Only Memory), a bus 130 connecting the BMC 110 and the storage unit 120, and a plurality of interfaces comprising IPMB 142, KCS 144, UART 146, and LAN 148 channels connecting to various consoles (152, 154, 156, and 158). The bus 130 between the BMC 110 and the storage unit 120 may be an I²C implemented bus. The storage unit 120 comprises SEL 121, a SDR repository 122, FRU information 123, a user message list 124, and an authority table 125. The SEL 121 is generated if a specific event occurs in the system. The SEL 121 records the status information of a sensor or the system corresponding to the event. The SDR repository 122 provides the properties of the individual sensors present on the board. The FRU information 123 comprises the inventory information, such as vendor id, manufacturer, and others of the devices. The user message list 124 comprises at least one user message, but not limited thereto. It is to be understood that the user list 124 may have no user message in some cases.

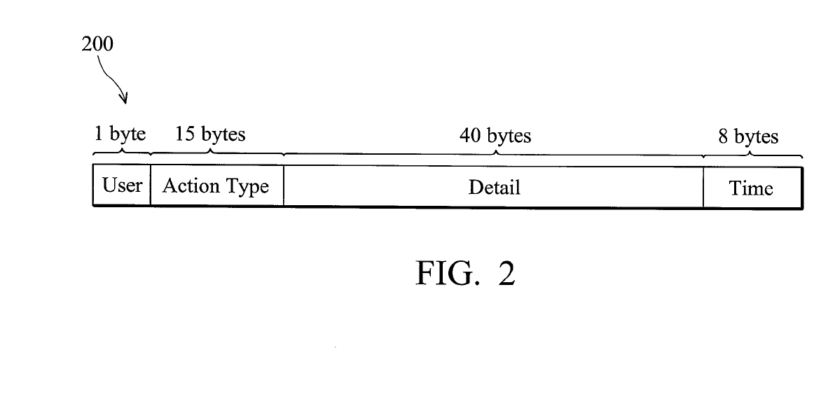

FIG. 2 is a schematic diagram illustrating a format of a user message. As shown in FIG. 2, a user message comprises a 1-byte user field, a 15-byte action type field, a 40-byte detail field, and an 8-byte time field. It is to be understood that the format of the user message is not limited thereto.

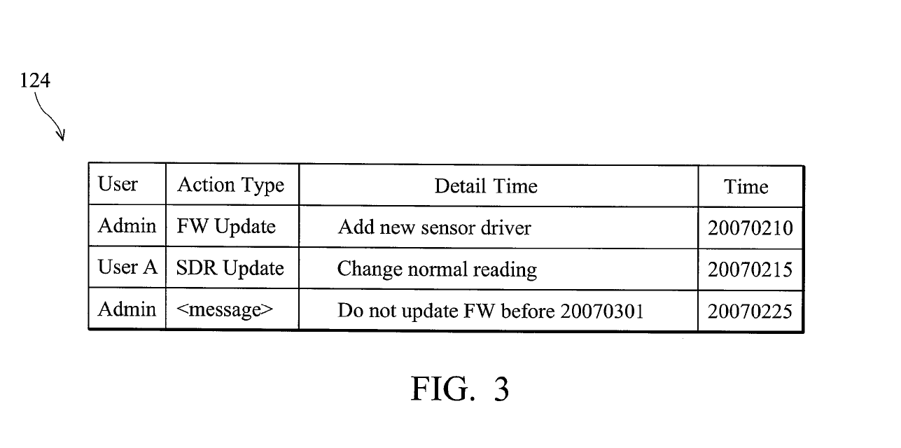

FIG. 3 shows an example of a user message list. As shown in FIG. 3, three user messages are in the user message list 124, each recording user identification, action type, detail descriptions, and timestamp corresponding thereto. The consoles can access the user message list 124 via the BMC 110. The BMC 110 receives requests from the consoles, and performs the user message management accordingly. It is to be understood that, in some embodiments, the request has a layered structure.

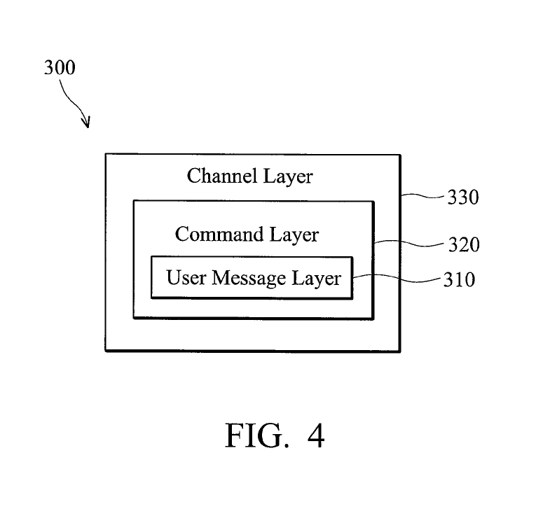

As shown in FIG. 4, the request is layered by encapsulating the user message layer to a command layer corresponding to an access such as read, creation or deletion, and encapsulating the command layer to a channel layer corresponding to the channel between the console and the BMC 110.

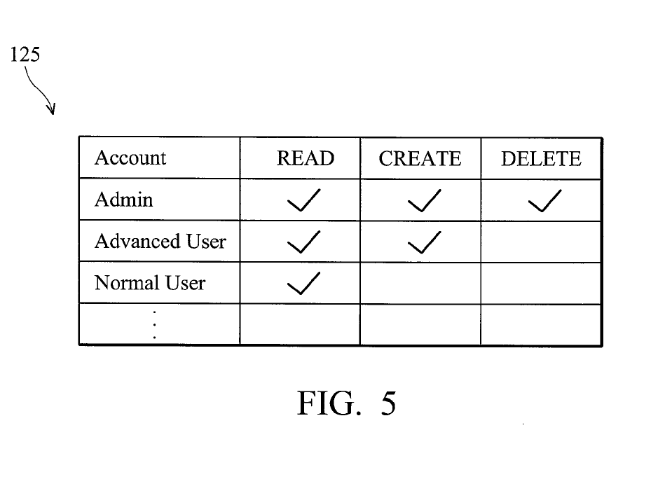

FIG. 5 shows an example of an authority table. As shown in FIG. 5, the authority table 125 records the authorities of respective console to the user message list 124 shown in FIG. 4. Each entry in the authority table 125 records an account type, and authorities for read, create and delete to the user message list 124. It is to be understood that, in some embodiments, the authority table 125 can be in the BMC 110.

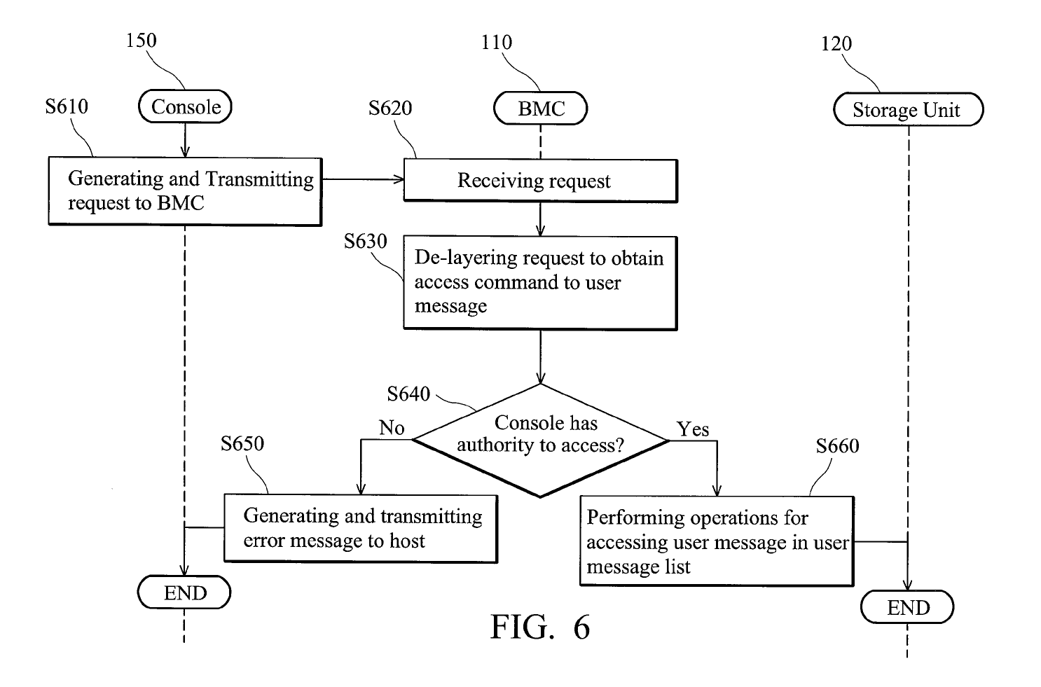

FIG. 6 is a flowchart of an embodiment of a user message management method.

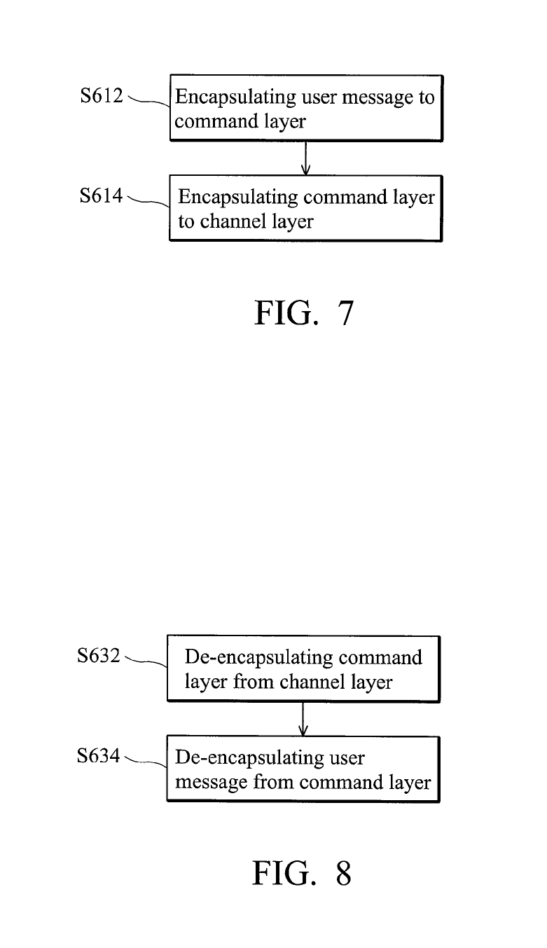

In step S610, a console 150 generates and transmits a request to access the user message list to the BMC 110 via the IPMB, KCS, UART, or LAN channel. In some embodiments, the request comprises a user message. FIG. 7 is a flowchart of an embodiment of a request layering method. In step S612, the user message is encapsulated to an access command such as creation, read, deletion in the command layer by layering the request. In step S614, the access command comprising the user message is encapsulated to channel information corresponding to the channel between the console 150, for example but not limited thereto, and the BMC 110 in the channel layer by further layering the request. It is noted that, in some embodiments, a message id for the user message or no user message may be in the request if the action command is to read the user messages in the user message list 124. In step S620, the BMC 110 receives the request from the console 150, and in step S630, the request is de-layered to obtain the access command for the user message. FIG. 8 is a flowchart of an embodiment of a request de-layering method. In step S632, the access command comprising the user message is de-encapsulated from the channel information, and in step S634, the user message is de-encapsulated from the access command. In step S640, it is determined whether the console 150 has an authority for the access command according to the authority table 125. If not (No in step S640), in step S650, an error message is generated and transmitted to the console 150. If so (Yes in step S640), in step S660, operations corresponding to the access command are performed on the user message in the user message list 124. For example, if the access command is ‘creation’, the user message is created in the user message list 124. If the access command is ‘read’, the designated user message is transmitted to the console 150 via the BMC 110. If the access command is ‘deletion’, the designated user message is removed from the user message list 124. Whether the access is succeeded or not, the storage unit may transmit the response information to the console via the BMC.

The user message management method and systems of the embodiments provide a platform for IPMI users to leave messages such as update information, and communicate with each other thereby, improving flexibility of system management.

User message management methods and systems, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A user message management method for use in an IPMI (Intelligent Platform Management Interface) system, comprising:
receiving a request to access a user message list in a storage unit from a console by a BMC (Baseboard Management Controller); and
performing operations by accessing at least one user message in the user message list based on the request.

2. The method of claim 1, further comprising performing the operations by creating, reading or deleting the user message in the user message list.

3. The method of claim 1, further comprising determining whether the console has an authority for accessing the user message list.

4. The method of claim 3, further comprising performing the operations if the console has the authority for accessing the user message list.

5. The method of claim 1, further comprising receiving the request from the console via an IPMB (Intelligent Platform Management Bus), KCS (Keyboard Controller Style), UART (Universal Asynchronous Receiver/Transmitter), or LAN (Local Area Network) channel by the BMC.

6. The method of claim 5, further comprising layering the request by encapsulating the user message to a command layer corresponding to the request by the console.

7. The method of claim 6, further comprising encapsulating the command layer to a channel layer corresponding to the channel by the console.

8. The method of claim 7, further comprising de-layering the request by de-encapsulating the command layer from the channel layer by the BMC.

9. The method of claim 8, further comprising de-encapsulating the user message from the command layer by the BMC.

10. The method of claim 1, wherein the user message comprises a user identification, an access type, a description, or a timestamp.

11. A user message management system for use in an IPMI (Intelligent Platform Management Interface) system, comprising:
a storage unit comprising a user message list; and
a BMC (Baseboard Management Controller) receiving a request to access the user message list from a console, and performing operations by accessing at least one user message in the user message list based on the request.

12. The system of claim 11, wherein the BMC further performs the operations by creating, reading or deleting the user message in the user message list.

13. The system of claim 11, wherein the BMC further determines whether the console has an authority for accessing the user message list.

14. The system of claim 13, wherein the BMC further performs the operations if the console has the authority for accessing the user message list.

15. The system of claim 11, wherein the BMC receives the request from the console via an IPMB (Intelligent Platform Management Bus), KCS (Keyboard Controller Style), UART (Universal Asynchronous Receiver/Transmitter), or LAN (Local Area Network) channel by the BMC.

16. The system of claim 15, wherein the console further layers the request by encapsulating the user message to a command layer corresponding to the request.

17. The system of claim 16, wherein the console further encapsulates the command layer to a channel layer corresponding to the channel by the console.

18. The system of claim 17, wherein the BMC further de-layers the request by de-encapsulating the command layer from the channel layer by the BMC.

19. The system of claim 18, wherein the BMC further de-encapsulates the user message from the command layer by the BMC.

20. The system of claim 11, wherein the user message comprises a user identification, an access type, a description, or a timestamp.
